(19) United States
(12) Patent Application Publication
(10) Pub. No.: US 2012/0178066 A1
(43) Pub. Date: Jul. 12, 2012

(54) Accelerated Reading Loop Bible, Reading Method and System to Encourage Bible Reading & Familiarity And Book Edge Coloring Technique

(76) Inventor: Ben Richard Drum, Garland, TX (US)

(21) Appl. No.: 13/004,739

(22) Filed: Jan. 11, 2011

(51) Int. Cl. G09B 19/00

(52) U.S. Cl. 434/245

(57) ABSTRACT

A sectionalized Bible and method to systematically expose readers to interesting broad divisions of the Bible by a new combination of:
a) A reading control system consisting of visually prominent new topical sections superimposed on the traditional Bible text with matching bookmarks together with
b) A method of reading a chapter or predetermined length from all such sections together in reading sessions that “loop” back to the beginning of a section on its completion while maintaining reading positions within each section by a prominent matching set of bookmarks.
   Such reorganized Bible and method providing advantages and motivation to modern short-attention readers wanting to “skip ahead” and “get to the good parts” quickly, or to focus on reading without pastoral explanations, discussions, meetings or travel. Such combination improves readability of any version of Catholic and/or Protestant Bible to grow familiarity, reading habit, and show relevance, connectedness and value of Bible content.

### REFERENCES CITED:

U.S. Pat. No. 7,631,870, Bennett
U.S. Pat. No. 2,556,474, Hurwitz
U.S. Pat. No. 3,175,305, March 1965, Marquart
U.S. Pat. No. 3,324,823, Peters
U.S. Pat. No. 4,445,196, April 1984, Gonet
U.S. Pat. No. 4,978,143, Ericson
U.S. Pat. No. 5,409,753, Perez
U.S. Pat. No. 6,244,628, Muller
U.S. Pat. No. 6,352,048, Scott
U.S. Pat. No. 3,200,029, G.M. Cross
U.S. Pat. No. 6,048,114, de Troz
U.S. Pat. No. 4,970,680, Walters
U.S. Pat. Applic. Publ. No. US 2003/0006969, Barras
U.S. Pat. Applic. Publ. No. US 2004/0076937, Howard
U.S. Pat. Applic. Publ. No. US 2006/0123352 A1, McClinton
U.S. Pat. Applic. Publ. No. US 2008/0005656 A1, Pang, Pang, Pang & Mullins
U.S. Pat. Applic. Publ. No. US 2010/0083162 A1, Hernandez

### BACKGROUND

1. Field

The invention relates to a new type of reading Bible, made to encourage and motivate Bible reading by frequent sampling of topical reading sections superimposed by color designation over Catholic or Protestant Bible versions with matching colored book marks.

2. Related and Prior Art

Prior art and tradition divided the Bible into Classical Old and New Testaments subdivided into Books, Chapters, and verses. No alternative division methods were found while maintaining the traditional text. Chronological Bibles that rearrange the text have been marketed but searches have yielded no patents for this type of Bible.

Churches, proponents of the Bible, and publishers have long urged its'reading, but made no changes to divisional organization of the Bible. Many reading approaches can be found in non-patent literature with suggested approaches to “reading” with exhortations, discussion, explanations, and aids to memorizing. Some Bible proponents read the Bible in the period of a year while some read certain sections and combinations of sections without a defining system.

Attempts to make the Bible more palatable were generally narrative summary, paraphrasing, interpretation or commentary upon classical main divisions, books and chapters—plus video, film and audio narrative, interpretation and “re-enactments”. There has been long reluctance to propose or consider any changes in Bible organization, which might have been seen as questioning tradition or God's own divisions. Churches have promoted tradition and dependency on teachers, preachers and illustrators, as if people could not or would not read on their own. Churches did not urge questioning of methods, leaders nor divisions of the Bible. Nor have hybrid techniques been patented for Bible reading, such as “immersion” and “frequency” as used for language learning, yet the Bible is like a foreign language to many.

State of prior reading traditions coming from churches and study groups consisted of reading a verse or a few verses, then discussing such with a leader interpreting or parsing each, looking for meanings, discussing context, and/or sometimes noting significance or how such might be connected to some other verse, prophecy, event or current life. Put simply, TEACHING is given more emphasis than READING, as seen in inventions such as (Bennett's U.S. Pat. No. 7,631,870) that employs a puzzle to aid a process of memorization of Bible content using the standard Old and New Testament divisions.

Prior art of inventions for Bible reading basically don't exist or reflect traditions of study and review similar to above as a) Bible lesson passages selection and review method (Gonet's US Pat. No. 4,445,196 Apr. 24, 1984 (A method of enhancing the learning and appreciation of passages from the Bible, to choose and re-sequence selected passages from a religious gathering for review)), or b) Means of quickly electronically selecting and displaying classical chapter-verse divisions using electronic devices (Barras's Pat. No. US 2003/0006969 A1 Jan. 9, 2003 (A hand held system of selection and display of verses within books, chapters)), but no method of reading.

Prior art attempting to address difficulty of classic Bible layout and naming by aiding memorization of Bible books' names and sequence—resorted to visual and manipulatory tools of a simulated Bible and note taking (Marquart's U.S. Pat. No. 3,175,305 Mar. 30, 1965 (A simulated Bible and book case to aid memorization of books sequence) while a broad pure system and method of reading has not been suggested.

Prior art of visually indexing Bible topics was limited to convenient, quick referencing books or verse content for study of verses related by topic of study consisting of adhesive color coded tabs (Muller's U.S. Pat. No. 6,244,628), and similar prior art sticker or label “tabs” to mark verse locations or identify verses in non-alphabetically arranged books like the Bible with index chart preprinted with topics and icons (Perez's U.S. Pat. No. 5,409,753), and book indexing stair-step tabs to number books of the Bible and locate special selections (Ericson's U.S. Pat. No. 4,978,143). All such patents were aids to “locating” or identifying classic verses or books for reference, study or review and not to encourage sequential reading.

Prior art of book marking related to tracking a plurality of selections to be read at will or in some odd sequence but not in a systematic way (Peter's U.S. Pat. No. 3,324,823). Prior art of multiple book-marking in Scott's U.S. Pat. No. 6,352.048 Doll Bookmark-2002 has acknowledged that Bibles are unique in some having had “colored ribbons sewn at the top of the spine for marking favorite passages” and “ribbons are not commonly available in books other than Bibles”, but no mention of a systematic way to use the book marks.

### SUMMARY OF THE INVENTION

In accord with all embodiments, this is a system and method to encourage Bible reading by frequent sampling of newly proposed topical reading sections superimposed over any Catholic or Protestant Bible version or translation. A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Purpose: It is an object of the “Accelerated Reading Loop” (ARL) Method to address a long-known “readability problem” of the primary source of religious knowledge for billions—that although the Bible is the all-time best selling and a profound book translated into more languages than any other book, it is purported to be the least read relative to its vast ownership around the world because some (mostly older) parts are difficult to read, tedious and seem irrelevant. This Reading Loop method Bible is especially advantageous to many, including certain special needs sub-groups of want-to-be readers as shown herein.

The present invention is built (superimposed) upon the classic Protestant and Catholic Bibles consisting of the OLD TESTAMENT [Five Books of Moses, History of the Kings of Israel, Wisdom Literature, Major and Minor Prophets] and the NEW TESTAMENT [Four Gospels of Jesus Christ, the History of Christ's Church and the Letters to the Churches] The Bible has been widely proclaimed as written by “Men Moved By The Holy Spirit Spoke From God” (2 Peter 1.21). Such Bible as a component of this method retains such classical structure underneath the ARL method's visually-indicated newly-superimposed “sections” structure.

Dividing the Bible into new topical Sections for systematic reading begins a fundamental new understanding of contents of the Bible and a learning process for a new reader or one who abandoned reading for a period. The Loop Method “immerses” the reader into the much-neglected area of church history in the book of Acts and letters to the church(es).

This new system of dividing and reading the Bible with “fast-broad-sampling” gives fresh insight into and appreciation of the Bible and formation of the Christian Church, reducing the perception of it as a cryptic old Book.

The unobvious result of this reading system and method incorporating a new multiple striped book edge with multiple matching bookmarks purposely identifies topical sections of the Bible and accelerates ones understanding of such topical divisions by reading them simultaneously to gain understanding of how topics relate within the entire Bible. The Bible thus defines itself to the reader quickly as no other proposed reading method has before.

The closest relevant art found is U.S. Pat. No. 6,244,628, Muller's Bible topic referencing system for traditional designations and The electronic Bible embodiments of Jeffrey B. Walters, U.S. Pat. No. 4,970,680; Selina Hernandez, Pub. No. US 2010/0083162 Al; Bryan L. Barras, Pub. No. US 2003/0006969 A1 and Previs Lamar McClinton, Pub. No. US 2006/0123352 A1.

While providing Bible text that maintain traditional divisions, these electronic Bibles fail to employ any system of reading or suggest any reading method. Most other biblically related prior art seems to involve, games, memorization or unrelated design.

### DESCRIPTION OF DRAWINGS

### Brief Description of Drawings—Figures

A more complete understanding of the invention is apparent from the accompanying drawings taken in conjunction with descriptions wherein examples of the invention are shown, and wherein:

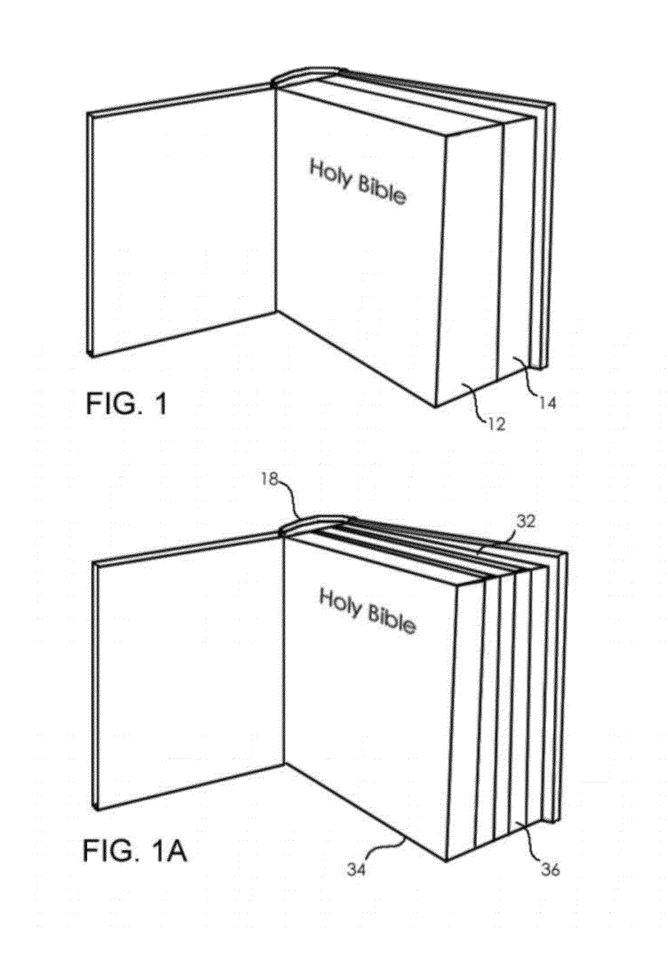

FIG. 1: is a perspective view of a basic Christian Bible with main classical divisions of Old and New Testament.

FIG. 1A : perspective view of a Christian Bible seen with five divisions instead of two and designating the anatomy of the books top, fore and bottom edges.

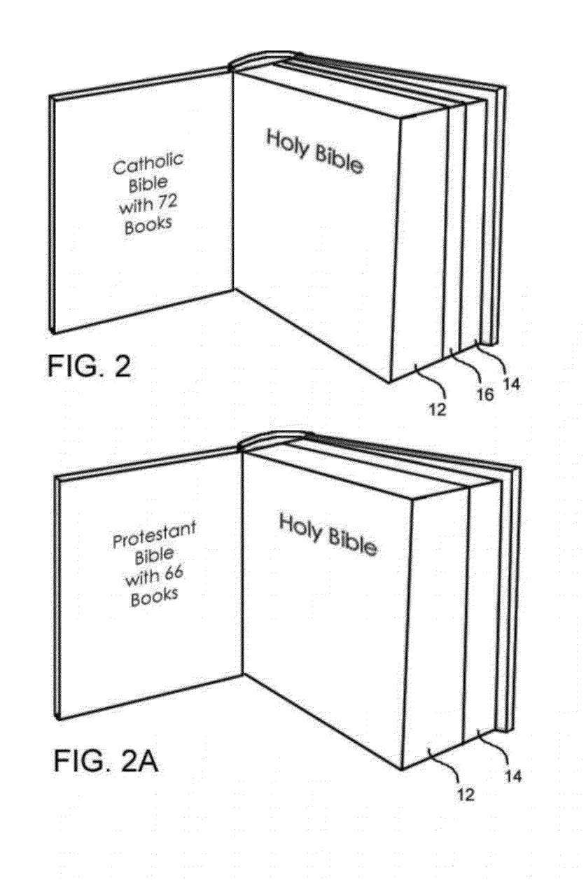

FIG. 2: shows a perspective view of a Catholic Bible and its' main classical divisions with notation of number of books.

FIG. 2A: shows a Christian Protestant Bible and its' main classical divisions with notation of number of books.

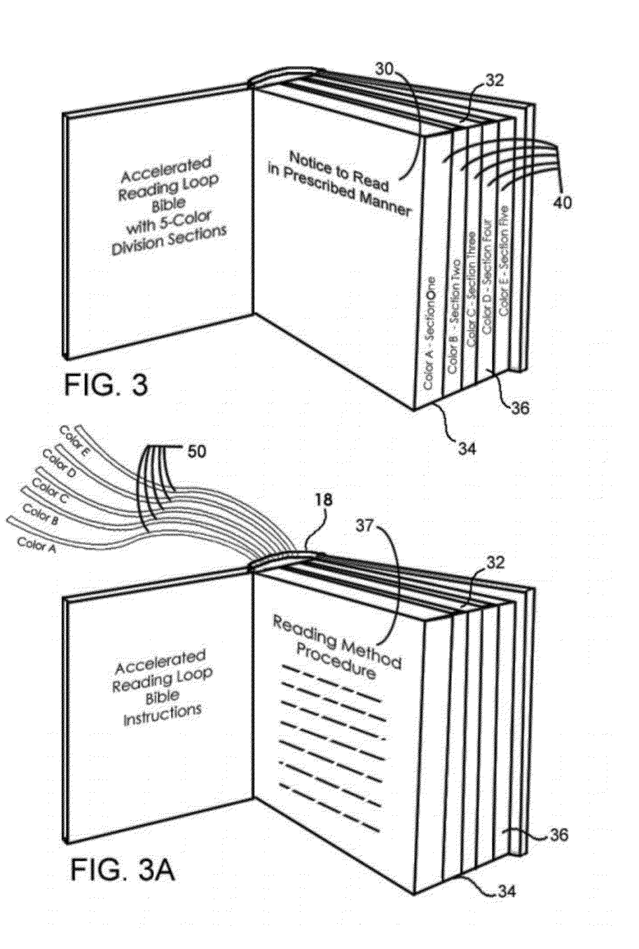

FIG. 3: Perspective view of the Accelerated Reading Loop (“ARL”) system printed book embodiment with five topical reading loop sections indicated by colored edges and “Notice to Read Instructions” on very front and/or inside front page of Bible.

FIG. 3A: Perspective of “ARL” Bible of FIG. 3 with “ARL Method Instructions” near front of Bible with five sections and multiple correspondingly-colored ribbon bookmarks.

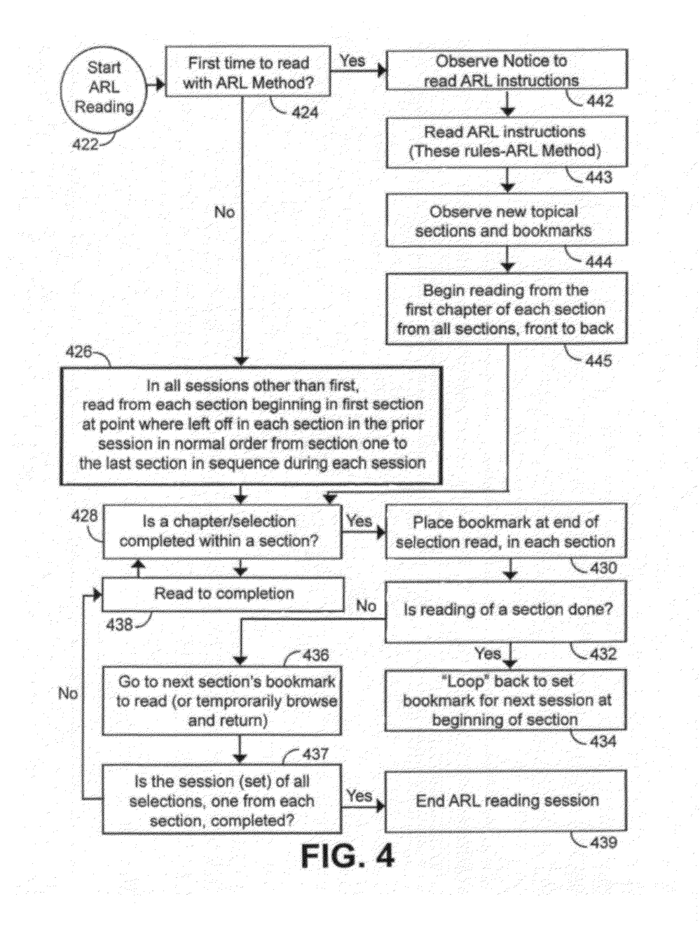

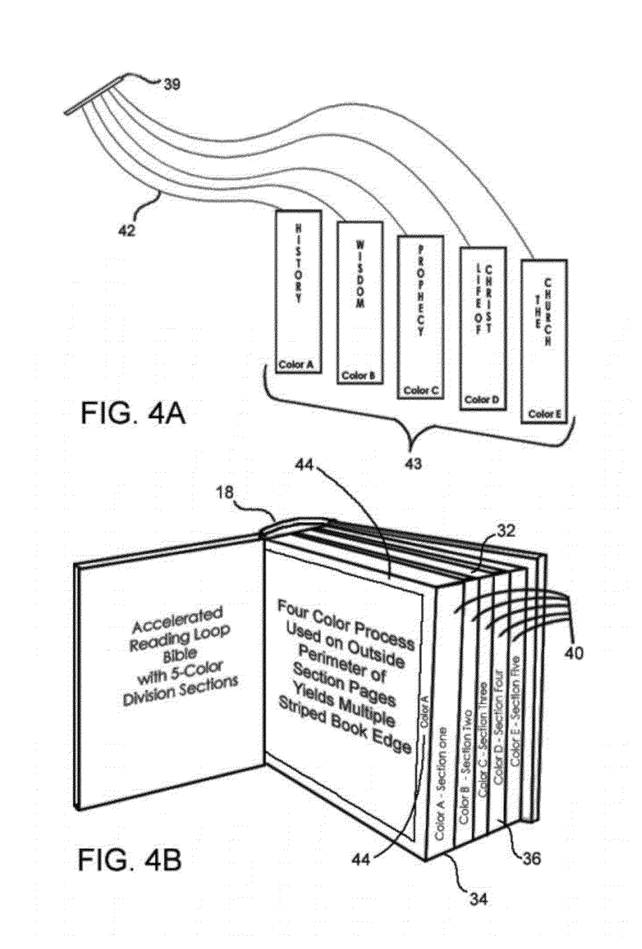

FIG. 4: Flow Chart of controlling Accelerated Reading Loop Method Instructions.

FIG. 4A: Perspective view of another version of bookmarks consisting of flexibly attached semi-rigid bookmarks in colors corresponding to sections.

FIG. 4B: Perspective view of “ARL” Bible with page perimeter coloring method to yield multiple striped book edge with four color printing process of every page in each section.

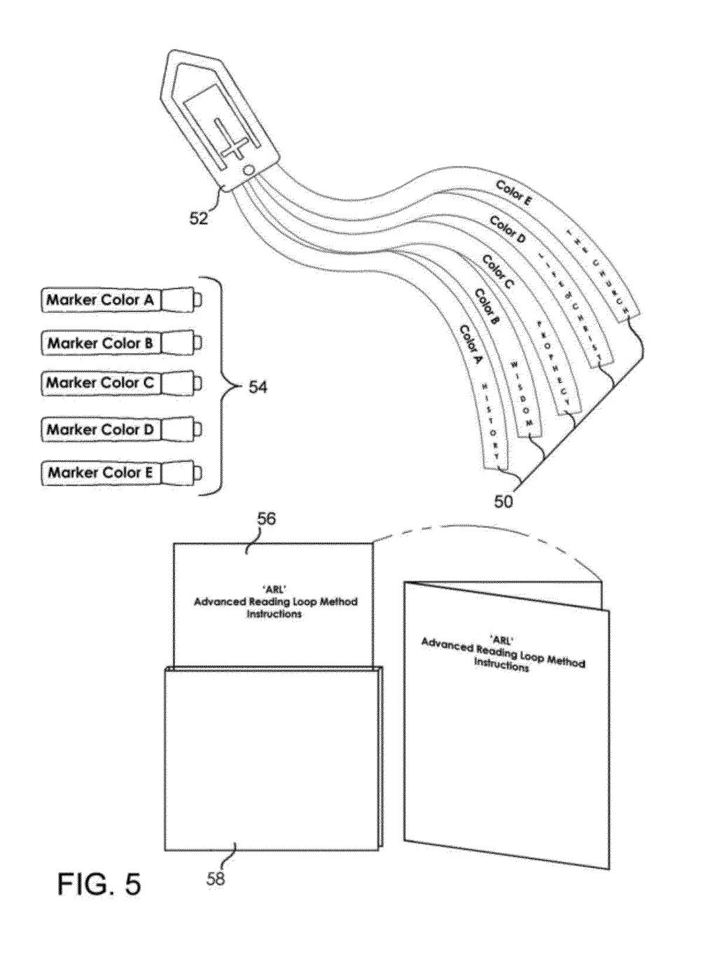

FIG. 5: Perspective view of the “ARL Transformation Kit” embodiment to convert a plain classic Bible into an ARL System Bible.

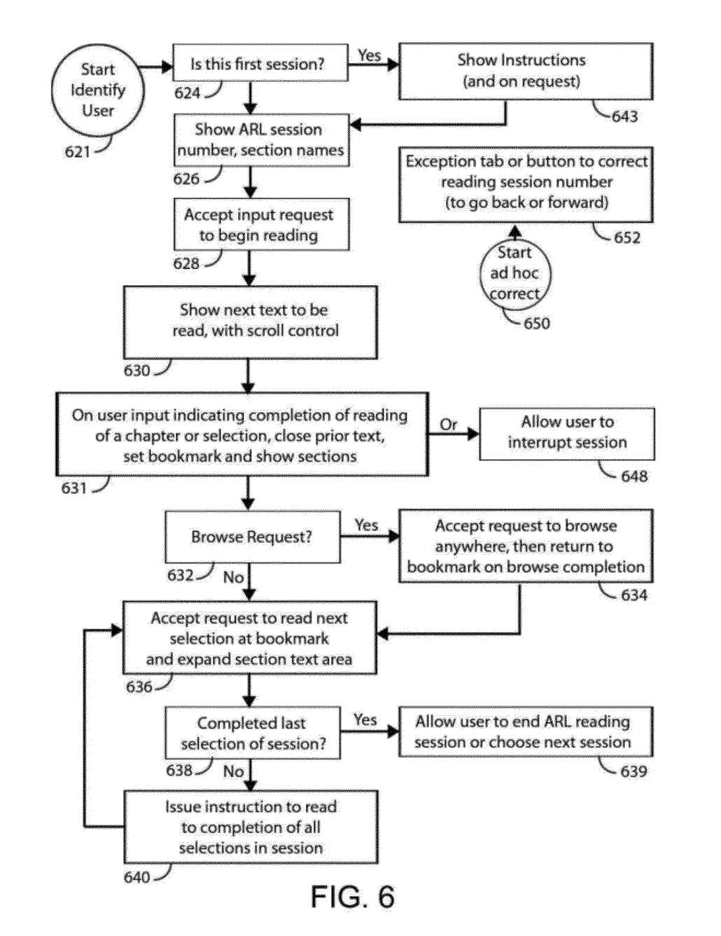

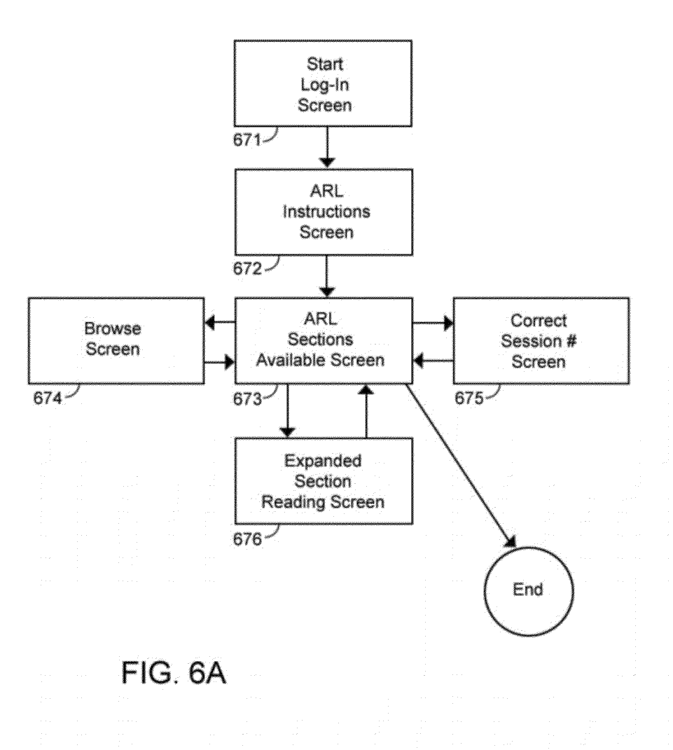

FIG. 6: Schematic flow chart of main functions of a computerized version embodiment.

FIG. 6A: A block schematic view of the main display windows of a computer-based embodiment implementing the ARL system and method.

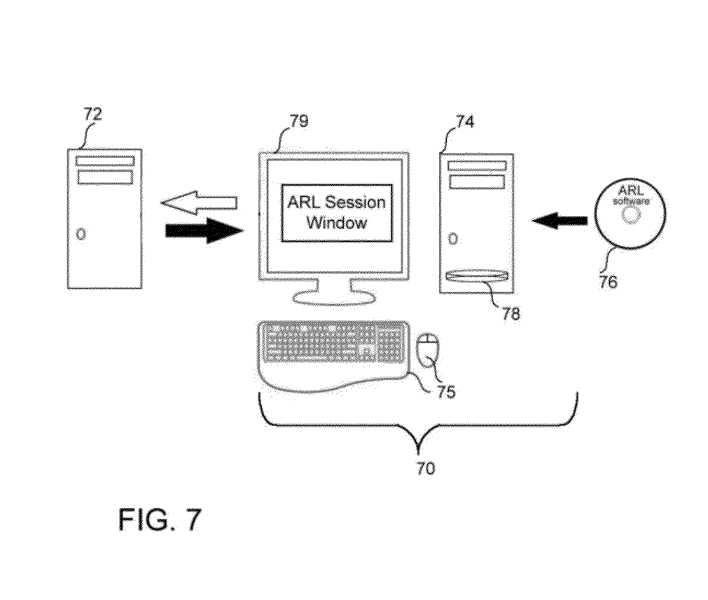

FIG. 7: Perspective schematic view of an ARL method and system computer version embodiment showing main functional system components.

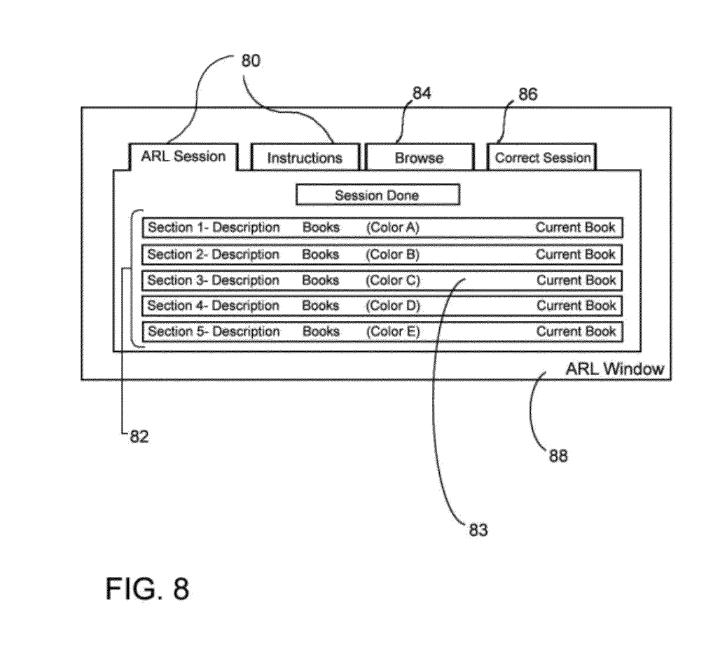

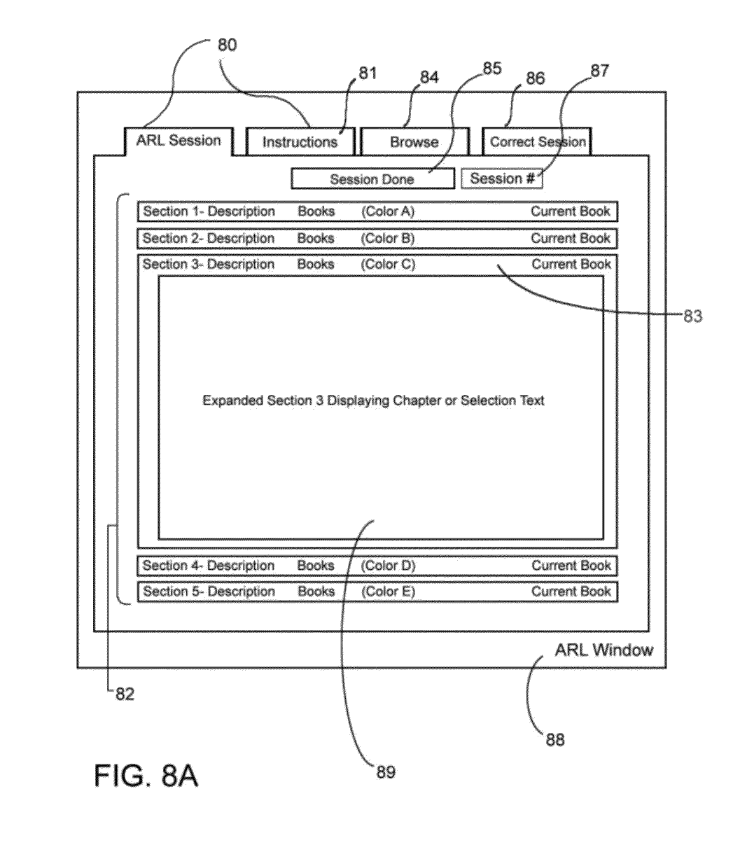

FIG. 8: Elevation diagram view of computerized page visual of available reading sections upon colored backgrounds by reading section in computerized method embodiment.

FIG. 8A: Elevation diagram view of a computerized version page presenting current section Bible text selection and indicating ARL topical sections by color and title of sections.

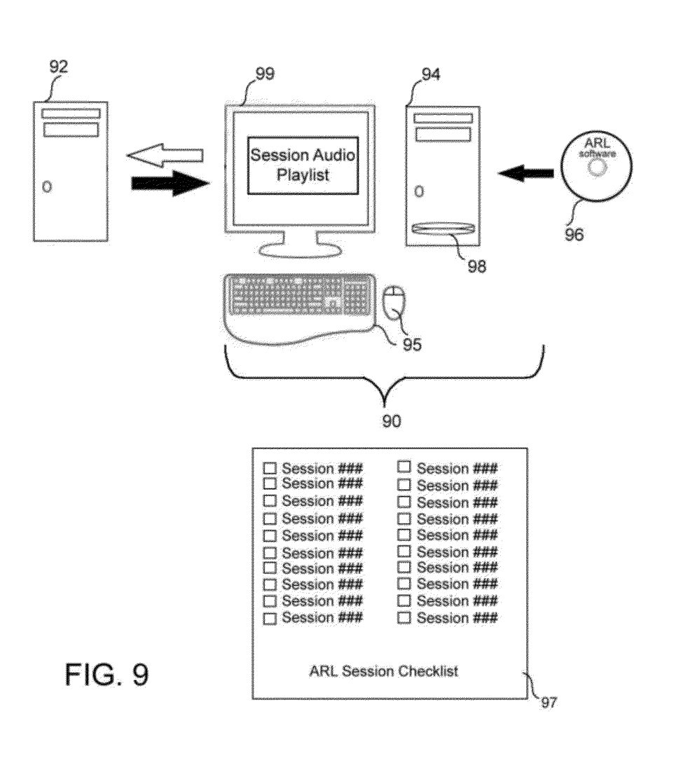

FIG. 9: Main components of ARL audio embodiment simulating print embodiments.

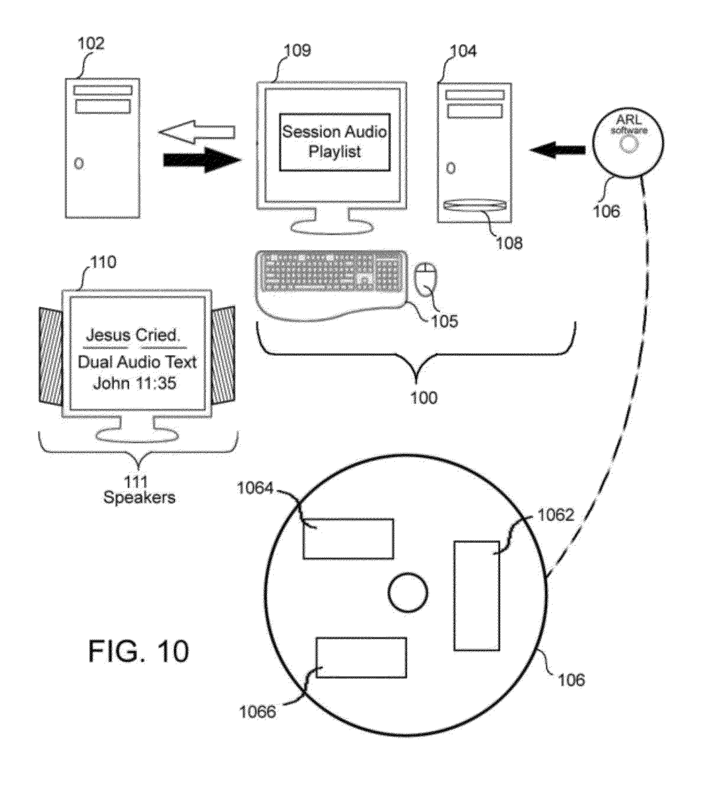

FIG. 10: Main components of ARL combined audio and text embodiment simulating print embodiments.

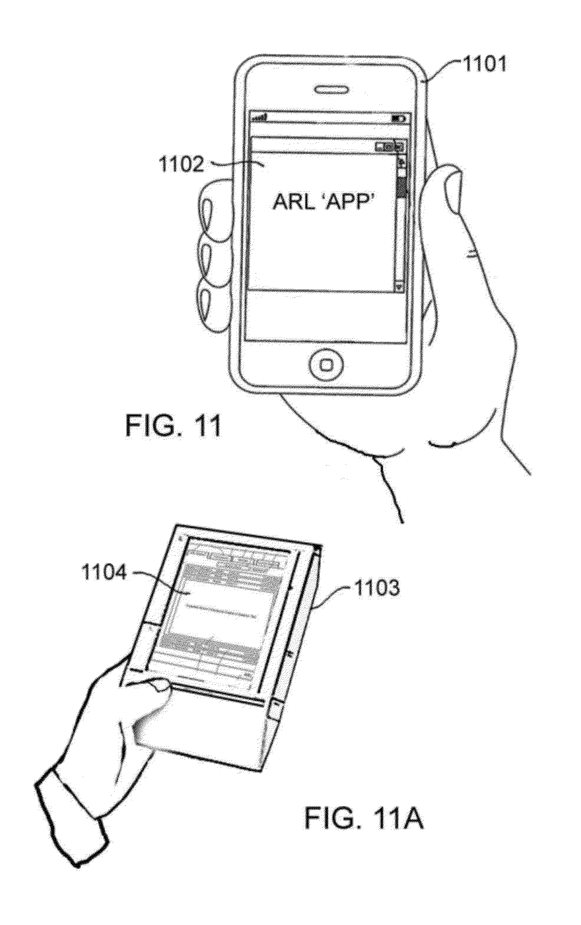

FIGS. 11 and 11A: Main components of ARL downloadable application and electronic reader embodiments simulating print embodiments.

### DRAWINGS—REFERENCE NUMERALS

Page 1—Contains FIG. 1 and FIG. 1A
Page 2—Contains FIG. 2 and FIG. 2A
Page 3—Contains FIG. 3 and FIG. 3A
Page 4—Contains FIG. 4
Page 5—Contains FIG. 4A
Page 6—Contains FIG. 5
Page 7—Contains FIG. 6
Page 8—Contains FIG. 6A
Page 9—Contains FIG. 7
Page 10—Contains FIG. 8
Page 11—Contains FIG. 8A
Page 12—Contains FIG. 9
Page 13—Contains FIG. 10
Page 14—Contains FIG. 11 and FIG. 11A

### DETAILED DESCRIPTION

Referring to the Figures, wherein like reference numbers represent like parts throughout the several views, exemplary embodiments of this invention are described, which may have specific values or parameters. Such are provided as exemplary embodiments, and do not limit the aspects and concepts of the instant invention because other comparable or usable parameters, ranges or values may be substituted:

### A) FIGS. 1-4C Manufactured Book Print Embodiments

FIG. 1-4C show the printed book embodiment of the Accelerated Reading Loop (ARL) system and method to encourage Bible Reading.

This system superimposes new topical divisions (sections) upon the classical Christian (Protestant and Catholic) Bible of FIG. 1-2A into three or more sections by visually identified topical content section topics similar to the following five-section Protestant Bible embodiment:

FIGS. 3 and 3A show perspective views of the Accelerated Reading Loop (“ARL”) system printed book embodiment superimposing five topical reading loop sections (divisions by type of content) upon such Bible of FIG.1 and FIG. 1A (with colors of sections indicated on the book's top, bottom and fore edges 32,34,36).

FIG. 3 shows prominent “Notice to Read Instructions” 30 on the very front and/or inside front page of Bible to make reader aware of importance of (i) reading the ARL Method Instructions 37 within front forward section and (ii) of closely following said instructions frequently for best results using the ARL Method sessions, book marking sections and goals.

Instructions 37 direct the reader to read one chapter (or pre-selected short text) from each new colored section of the Bible 40 (FIG.3) in sequence from front to back during each reading session, as frequently as possible. The corresponding bookmark 50 (FIG.3A) attached to Bible spine 18 in FIG. 3A is used to mark completion of each section during each session.

The Protestant Bible embodiment has radically different numbers of chapters in each ARL Section 40 (FIG.3) as shown herein:
Section One: Genesis through Esther . . . History . . . 436 chapters
Section Two: Job through Song of Solomon . . . Wisdom . . . 243 chapters
Section Three: Isaiah through Malachi . . . Prophecy . . . 250 chapters
Section Three: Matthew through John . . . Life of Christ . . . 89 chapters
Section Five: Acts through Revelation . . . Church History . . . 117 chapters

The ARL method instructs 37 (FIG. 3A) that when a reader finishes a section 40, the reader returns (“loops) to the beginning of the section, e.g., in this Protestant embodiment:
On session 437 in section 1 after reading Esther, the reader starts over in Genesis Ch. One;
On session 244 in section 2 after reading Song of Solomon, the reader begins Job Ch. One;
On session 251 in section 3 after finishing Malachi the reader begins again in Isaiah Ch. One;
On session 90 in section 4 after reading Book of John the reader returns to Matthew Ch. One;
On session 172 in section 5 after reading Revelation, the reader returns to Acts Ch. One.

When ARL Instructions 37 (FIG. 3A) are followed (with the exception of an optional brief discussion or browsing between or after sections) a reading session may time under 20 minutes and average about 23 minutes, which is an important key feature for busy people.

In this print embodiment exemplar, the “Accelerated Reading Loop” Bible has five new superimposed sections, “History, Wisdom, Prophecy, Life of Christ and Church History” superimposed on such prior classical designation of OLD and NEW Testaments 12,14 (FIG. 1). An alternative print embodiment would divide a Bible into six or more sections, such as to include the Catholic Apocrypha (Deuterocanonical Books) 16 (FIG. 2).

In all embodiments the “Reading Loop” method superimposes on the Bible three or more sections as in the preferred embodiment of FIG. 3 as shown below with explanation of alternative sections, and allowing for a Catholic Bible option:
Section One—History: Genesis through Esther (another embodiment could divide History into two sections by making the Pentateuch (Books of Moses) into a separate section.
Section Two—Wisdom: Job through Song of Solomon
Section Three—Prophecy: Isaiah through Malachi (Alternatively could be further divided into two sections containing the Major & Minor Prophets in another embodiment) (A Catholic Bible embodiment could add an Apocrypha (Deuterocanonical) section)
Section Four—Life of Christ: Matthew through John (Or the book of Acts could be moved to this Section as “Life of Christ and Church Formation” in another embodiment)
Section Five—Church History: Acts through Revelation (could divide into two sections: Church History and End Times in another embodiment).

Catholic Bible instructions and form embodiments provide an additional option whether to read from the Apocryphal Books 16 FIG. 2 and read six sections per each session.

Illustrated in FIG. 4 is the flow chart of the rules of the ARL reading method, from the very first reading session start 422. In the first time to read with ARL method 424, the reader sees Notice to Read ARL Instructions 442 whereupon such instructions are read 443 which teaches to notice 444 new topical sections 40 (FIG. 3) and bookmarks 50 (FIG. 3A), and then begin reading from the first chapter of each section from all sections front to back 445. Subsequent sessions begin at point book marked 426,436 where left off as below.

When reading of a section is entirely done 432 (FIG. 4), reading “loops” in next session to restart at the beginning of that section 434, hence called a “reading loop”. When a shorter section “loops back”, reading in the other sections continues where each left off. When the session set of five sections is complete 437 the ARL reading session ends 439. At any point between selections, reader may temporarily browse elsewhere in Bible 436.

As to ARL Method's instructed reading amounts, preferred embodiments instruct to read one chapter from each section per session, but a like-size brief selection (such as a fixed number of verses or a pre-defined number of verses visually identified by separator marks (or computer allocated in computer embodiment)) from each section 40 (FIG. 3) may be substituted for such one-chapter for equalization or other adjustment purposes of amount of text from each section per session.

A reader may temporarily over-ride a session's section sequence to “browse” or scan for any special purpose 436 as in ARL Rules Flow Chart FIG. 4.

In all embodiments, as in print embodiment exemplar of FIGS. 3 and 3A, the core features and elements remain: Notice to read and follow Instructions 30, ARL method instructions (rules) 37, section 40 visual identifiers 42 and multiple bookmarks 50 to enable reading by ARL rules 37 from each section the subsequent text selections during each of frequent sessions, and “looping back” to beginning on completion of each section.

### Similar Print Embodiment Adding more Section Identifiers

All print embodiments feature at least one visual means of identifying sections, such as multiple book edge color 40 (FIG. 3A). In addition to edge and/or page color section identifiers, additional section identifiers can be added, such as front of section descriptive page divider printed with descriptive title or upon a tab. Such are to aid the reader's identification of ARL sections, plus help reader to track reading progress. Such ARL control system's visual indicators (schema edge colors, tabs, and/or dividers) and descriptive titles of sections also reveal the span of each section 40.

Further section identifiers, such as section name on every page can be used to improve section identification. Any good means to identify sections and pages within each by color, dividers and/or descriptors meets the section identification feature-element.

In all embodiments the invention provides means for the reader to readily see a characteristic color of each section 40.

Using a four color print process to distinctly color the full outer perimeter of each sections pages is one claimed way to achieve a multiple striped Book Edge 44 (FIG. 4B) upon the entire page edge 32 (Top Edge), 36 (Fore Edge) and 34 (Bottom Edge). Computer embodiments have a colored background or bar on each page, plus section descriptor.

### Similar Print Embodiment Using Semi-Rigid Bookmarks

FIG. 4A shows another version of bookmarks in the book embodiment using semi-rigid bookmarks 43 in colors corresponding to sections 40 flexibly attached 42 to spine 18 by attachment strip 39, replacing ribbon bookmarks 50 of FIG. 3A in the preferred print embodiment otherwise unchanged. Flexible material such as string or ribbon (here shown using string) 42 are of length appropriate for flexible bookmarks 43 to each fall near mid-page and protrude from the books bottom edge.

Like the print embodiments using ribbon bookmarks 50 above as in FIGS. 3 and 3A, bookmarks 43 of a semi-rigid material like plastic, composite or laminated card stock may each include a short description of the corresponding section, as in a Protestant print embodiment being History, Wisdom, Prophecy, Life of Christ and Church History (and may both or alternatively describe section contents and/or a related inspirational) as shown 43.

### FIGS. 5-11A Alternative Embodiments

### B) ARL Bible Transformation Kit Embodiment:

FIG. 5 is an “ARL Method Transformation Kit” to convert a plain classic Bible into an ARL Bible by providing ARL system kit components for attachment and application onto a Bible, resulting in a Bible similar to a factory-produced print embodiment.

The “Accelerated Reading Loop” Method “Kit” (FIG. 5) transforms any Bible into an “ARL” Reading Method Bible like that of FIGS. 3 and 3A combined by supplying different colored markers (or ink rollers or colored dividers with tabs) for each section, with instructions on how to apply same to color a Bibles' book edges FIG. 1A (or in lieu using colored adhesive section divider tabs) to divide such existing Bible into new ARL topical sections 40 of FIG. 3.

Included in such “Transformation Kit” would be a set of three or more colored Bookmark ribbons (corresponding to chosen preset sections) printed with section names, provided with instructions on how to fasten such ribbon set 50 held together by a “bookmark clip” 52 onto the Bible spine 18 using said clip 52.

ALR Kit Installation directions and ALR method instructions 56 would be included in such “ARL Bible Transformation Kit” to be attached within front of Bible 37 (FIG. 3A) to be held in a pocket 58.attached by adhesive strip or directly by adhesive on back of back page of instructions 56.

ARL Kits are designed to be selected for three or more sections depending on the target Bible and topical sections chosen by the user. Simulating the print embodiment of FIG. 3A, the ARL Kit of FIG. 5 applied to a reader's existing Protestant Christian Bible (FIG. 2A) is illustrated in FIG. 5 with five sections and kit components in exemplar as following:

(1) Five markers 54 to color the Bible book edges with instructions on how to use same with (2) a set of corresponding five Ribbon 50 or semi-rigid Bookmarks 43 (FIG. 4A) mounted to spine clip 52 to attach to a personal Bible. (In an alternative version, such correspondingly-colored Bookmarks designating each ARL section could be semi-rigid and provided loose, or similar to ribbons 50 above in FIG. 3A attached to bookmark spine clip 52, or such set attached to spine by means such as adhesive peel backing on a strip to which ribbons are attached), (3) ARL Method Instructions FIG. 5 insert 56 in a pocket 58 to be placed or attached inside front of existing Bible FIG. 2A.

Installed by an owner of a classic Bible, the ARL Kit components together provide means of installing and using the ARL system and method on most Bible versions.

### C) ARL Computerized Embodiment: © 2010 Ben Richard Drum

FIGS. 6, 6A and 7 show a computerized embodiment of the ARL system and method.

FIG. 6A shows block diagram of main ARL display screens within the ARL window: Log in screen 671, ARL Instructions screen 672, Sections Available screen 673 indicating book marked current section and page of reading position (more detailed in FIGS. 8,8A), Expanded Section Reading Screen like prior screen but showing text currently being read 676, Browse screen 674 and Correct Session number screen 675 to correct session number by manual over-ride as in flow chart FIG. 6, blocks 650, 652 based on reading a chapter or selected amount of text from each section for every full reading session.

FIG. 6 shows a flow chart of main ARL functions of the computerized version simulating ARL system print embodiments. Such ARL functions are run by programs and data, which present the ARL system and method upon a user's local computer system 70 in FIG. 7 with storage 78 of user-indicated book marking of progress while allowing temporary jump to browse any section 632, 634. ARL section sets of selection text for each session are the main data stored and used to enforce relative text of each session determined by ARL rules of FIG. 4. Such ARL sets are stored by session number keeping selections correctly positioned relative to each other by ARL rules. Computerized enforcement of such fixed relative selections is an advantage of the computer embodiment.

FIG. 6 illustrates flow of the main basic functions and actions from start 621 log-in to determining whether this is this user's first session 624 or identify a user matched to stored session and book mark tracking 626 also. If first time, ARL rules and operation instructions are shown 643. In every case, then the ARL session number and corresponding selection names are shown 626. User-reader indicates readiness to begin reading 628 whereupon the current section is expanded to show next text selection to be read with text scroll control for long selections exceeding window size 630. The reader indicates completion of a chapter or selection and such prior read text is closed, book mark set and all sections are shown 631, 82 as in exemplar of FIG. 8 showing diagram of ARL computerized reading window. Alternatively to continuing a reader may interrupt the session to return at a more convenient time 648. Alternatively to continuing, a user may request to browse anywhere 632, which is allowed, then returning reader to current bookmark on browse completion 634. On request to continue reading within session at bookmark, the program again shows correct selection text, such as by expanding that area of the window 636 as in FIG. 8A 88. If the last selection of session is completed 638 the user may end ARL reading session or go into another session 639. Else, the program issues instruction to continue reading to completion of all selections of the session 640 and waits for user request to read next selection whereupon that text is presented 636.

FIG. 6 also shows an ad hoc correction mode 650, 652 as in FIG. 8A by tab or button 86 which exception allows permanent over-ride correction of ARL reading session number to go back or forward.

FIG. 7 shows the local user system 70 components including computer CPU 74, local main storage 78 and display 79 to implement a program and data simulating the ARL method print version coming from or residing on Internet server 72 or from off-line media 76, which (a) tracks (stores and returns) reading position as bookmarks within sections from session to session to present each current section's book marked Bible text one-at-a-time as read, which (b) stores reading position in relation to stored computerized Bible's text presented on (c) display screen 79 which presents the main ARL windows after sign-on of (i) one window presenting ARL method instructions with operation instructions and (ii) next window page being the main session and section control and Bible text presentation page that also allows secondary exceptional browse or correct functions.

An internet or network server 72 can interactively provide the user session functions and data on display 79 utilizing CPU 74 as a platform for internet browser or window. Alternatively the embodiment may be mostly run upon a local CPU 74, or a server 72 may share functions with local CPU 74 and display 79. A server may provide ARL software and Bible selections data for download to wholly off-line operation upon the local full function computer system 70, with its parts 74, 75, 78, 79. Removable storage media containing prepackaged ARL software and data 76 could be utilized to run from such media 76 or copied for install to be stored 78 and run entirely upon the local system 70.

FIG. 8 shows the computerized ARL method version that allows (a) a user-selected tab or button 84 for browsing-scanning of non-book marked Bible content without resetting the program's internal reading point bookmark at option of user as a temporary scan, or (b) a mode button 86 to force a reset session to a new “set” position-session number 87 FIG. 8A.

The computerized embodiment currently enabled by Javascript language offers advantage of calculating and moving bookmarks of sections after reading said chapters/selections and keeping such selection “set” pointers always aligned programmatically as strictly stored together in sets according to session number, unlike the manual method. Typical application of such reset 86 would be to go back one or two sessions. The reader cannot accidentally mix up matching ARL-determined sets each separately stored together.

In the computer embodiment of ARL method, the following features are provided :
(a) A Browser-like “window” or area 88 FIG. 8 on display 79 FIG. 7 for ARL instructions, program status and control 80, indications, Bible page text presentation 89 FIG. 8A and user-reader input (via input devices 78 FIG.7) providing the ARL functions and features.
(b) After initial sign-on screen and user identification with notice and option for instructions screen (first session is not optional-must show),
(c) within said window 88, this embodiment displays a main “screen” or “page” with six areas as in FIG. 8A:
i) showing current program main function and functions control options (such as “browse”, “read”, “instructions”, “correct session”, using control tabs or buttons 80,84,86;
ii) displaying 79 available section descriptors or titles, upon or near their matching colors 82;
iii) displaying 79 FIG.7 stored 78 tracking of current session number 87, last bookmark and completed sections;
iv) highlighting or indicating user's book marked or active current section's reading section descriptor or title (in a button area or line) 83;
v) showing current active reading selection's text with section color around perimeter of screen where text appears corresponding to section color 89;

Relating Flow Chart of FIGS. 6 and 6A to Hardware Functionality of FIGS. 8 and 8A show ARL window 88 display areas, buttons and/or tabs 80, 84, 86, 85, 87 and input means 75 to:
1. On start, identify user 621, show Notice to follow instructions and show instructions 643
2. After Notice, show main ARL window 88 showing ARL structure of section names and colors 82 and controls 80, 84, 86 (FIG. 8) 85, 87 (FIG. 8A).
3. On beginning a session, highlight the next book marked selection of the Bible to be read, and upon selection of said section expand section to show text area to be read 630, 89 (FIG. 8A).
4. Track and store 74 (FIG. 7) such reading progress point (bookmark) indicated on display 79 based on user input 75, for example by clicking a “Done” button 85.
5. On request by tab 81 show detailed Accelerated Reading Loop Method and Operation

Instructions explaining that the ARL computer program implements the ARL method. Include computer embodiment operation instructions explaining display and controls 80, 81 84, 86, 87 of FIG. 8A (83 (FIG. 8)is section expand or reduce highlighted section).
6. On user indication 83 of a chapter or selection completion by closing text area 89, advance reader to next section's book marked selection to be read and on request to continue reading 636 (FIG. 6) show “next-to-be-read” text 631, 632, 89 (FIGS. 6 and 8).
7. After user closes selection text, indicate next selection to be read as in flow chart 631 and seen on screen 83 allowing for start of a session at either first section's selection 426 in (FIG. 4 Flow Chart) or for re-starting in mid-session at bookmark just after last selection read (in case a session is interrupted) 648.
8. When user indicates completion of a session's set of sections 85, the program records completed session number 87 shown in Flow Chart FIG. 6, 638, 639 (counting from original session number one), such controlling session number enabling restoration of relative sections to any session by input of a desired session number 87 (FIG. 8).as in flow chart 652.
9. On demand 632 allow temporary over-ride ability to browse to any Bible text (prior or other) for review, scanning or ad hoc reading 634, but retaining session bookmark.
10. Even on option to over-ride for browsing 632, store and keep current session's book marked reading position section in storage 78 (FIG. 7) or from server 72.
11. Provide function of exceptional permanent over-ride to correct current reading position by input of new Session Number 87, 632.

This embodiment can utilize additional visual indication of current reading section by a like-colored bar in a control area of an ARL window highlighting such section name.

### D) ARL Audio Embodiment

FIG. 9 shows an Audio ARL embodiment based on basic ARL rules (of FIG. 4A) simulating main functions and features of ARL print embodiments, which a) sequentially present brief selections from each of all sections within each session, b) book-mark position of next selection to be read in each section c) loop the reader and book-mark back to the beginning of a section upon section completion, and d) allow “over-ride” functions to temporarily “browse” any Bible part with ability to return to reading session, and to permanently change-reset book marked positions to the beginning of any session number.

Like the computerized embodiment, the local audio system 90 is based on stored files each containing session “sets” of each session's fixed selections or chapters. Sophistication can vary from a simple player, like a CD player to a computer-based sound player 90 or specialized software on such a system 90 and CPU 94 with local storage 98 operated by input devices 95 and observing a display 99. Each file is one “session”. Each session number is based on a set of files of a narrator reading such selections or chapters sets per session. Such sound file sets can be accessed by the user's player or computer by usual sound file playing means such as downloading, streaming audio, or local media such as CD, DVD, and may run directly from a CD or DVD, like a plain “player”. Well-known means 92, 96 of audio file sets delivery common to various electronic players or computers, each set similar to an “album” collection of audio pieces—can be utilized in accord ARL audio embodiment application.

Book-marking of sessions progress is accomplished by the listener manually marking off each completed session “number” upon a pre-printed session completion checklist or log listing session numbers 97. If the listener is interrupted, he or she may mark the section completed within the session and later return thereto using the audio player's manual scan forward function, such as a slider on a computer sound file sound player control display, scan on a CD player or a fast forward, or simply by listening again or fast-forwarding through prior completed sections of the current session, which takes little time.

Such checklist or log to be marked 97 is in the ARL sound media container (like inside a CD holder) or downloadable to a computer to be printed out, or displayed by a computer program that presents and plays such ARL audio file sets like modern music file players display file names or keep files in a “play list” 91. An advanced player which can track and store progress in a play list can substitute for manual logging 97 of bookmark of session progress.

The ARL audio version may contain any number of sessions in each package.

Advantages to the audio version are mostly hands-free operation while driving or before going to sleep in bed or doing boring tasks. People with vision problems or who are poor readers appreciate such embodiments.

### E) Dual Audio and Computerized Embodiment

This Application Combines features of FIGS. 6, 6A, 7, 8, 8A and 9 in a single system as in FIG. 10 provides a “dual embodiment” utilizing both computerized embodiment of FIGS. 7, 7A, 8, 8A and audio embodiments of FIG. 9 into one presentation platform. This embodiment is simply the two above embodiments, computer (text) and audio, residing on one local user system 100 like the system 90 of FIG. 9 and of FIG. 7 70 which are functionally the same hardware with dual software 96 and file sets for choice text mode or audio, as the user prefers.

An advanced model with features like U.S. Pat. Applic. Publ No. US 2008/0005656 A1, Pang, Pang, Pang & Mullins combines both and presents the text in audio while displaying each word of the ARL reading session on a monitor or handheld screen with an underline or highlight which has the advantage of helping anyone to learn to read or read better and improve pronunciation in whatever language the text is translated into while learning the Bible story, See 110 FIG. 10

This method is beyond a mere sound player and must be computerized to offer either “text” or “audio” option on one computerized device-system 100 with likewise CPU 104, storage 108, input devices 105, display 109 and alternative web server 102 substituting for software and audio file removable media 106. Such “dual embodiment” option overcomes difficulty of reading electronic displays in bright sun or while driving, but utilizes one computerized device as a platform for both modes.

In FIG. 10, a “session-set” is the set of relative selections for each session, whether text or audio. As shown in the lower detailed view of the ARL media 106 in this dual-embodiment version, the ARL data of session files contains both digital “text” session-set files 1064 and audio session-set files 1066, in like sets of the number of sections per session, and by session number. These are selected and presented by ARL software 1062 emulating the text and audio embodiments.

### F) Downloadable Application

Hand held mobile device usage has now permeated much of the United States and other countries in the world. Increasingly more hand held mobile devices are now made WIFI ready, capable of online web access. A Downloadable Application Embodiment is now quite familiar as DROID and other “app” providers have made thousands of game programs, navigation tools, weather forecast and a host of various downloadable applications available for mobile device access.

The ARL Method was developed using Javascript and can be accessed and/or downloaded onto a compatible electronic device 1101 (FIG. 11) with Javascript enabled or made to function with any preferred web, mobile or computer language.

One embodiment would use a browser and just be considered an offline “web browser application” 1102 FIG. 11. A windows application can be made to display html pages that would allow for navigation of the ARL Bible Reading Method pages and tracking of the reading progress by book marks (via cookies or some other mechanism). A web browser or Windows “App” would have the basic functionality described in FIG. 6 and display in a similar fashion as FIGS. 8 and 8A.

### G) Electronic Book Embodiment

The use of wireless reading devices with WIFI capability is growing and many people are changing preferences from traditional paperback or hardback books to “Electronic Books”. The Electronic Book of choice is now the “Kindle” 1103 (FIG. 11A) and allows a user to go online to Amazon or some other provider and pick a novel or book for download 1104 and virtually eliminate all physical books but the electronic reading device itself.

To obtain the functionality of the preferred ARL Reading Bible for the electronic book, each new topical section is separated into five books for the Protestant Bible or six books if the Apocrypha (Deuterocanonical books) is included for the Catholic version. The “Kindle” or similar electronic book would keep track of the book mark for each section to give the functionality required in the rules for applying the ARL Bible Reading Method as described in FIG. 6 and display in a similar fashion as FIGS. 8 and 8A.

### Advantages:

For beginners, the ARL method and System immediately reveals a more meaningful overview of Sections and their content, purposes and relationship to each other. The method helps advanced readers maintain continuity by frequently viewing the connectedness and importance of sections. For both beginner and expert, the method helps maintain interest and “freshness” by a quicker more satisfying view of “fulfillment” of scriptures, reaching the captivating story of Jesus' life and the culminating Church formation, even from the first reading session.

The Accelerated Reading Loop Method accommodates what prior art ignored: that many people have no expert to explain, little time to listen, and just want to read first-hand “The Word” itself unfiltered. The Loop Method is distinguished from tradition that gave little credence to individuals' ability simply to read enough of the Bible often enough to appreciate it on their own. Prior art and mostly tradition did not promote readers' independence or to provide a systematic way of reading to quickly understand the whole Bible Story.

### Problems Associated With Bible Reading Addressed:

1) Use of the Reading Loop Method a few times per week gives the reader a greater understanding of Bible “connectedness” proportionate to usage of the Method.
2) The common problem of disinterest due to unfamiliar dry Bible passages is alleviated when using the “Reading Loop” method by a mix of interesting reading always a part of each session of 3 or more chapters (or short selection).
3) As a reader logs more sessions, Old Testament events mentioned in the New Testament are noticed more frequently so the Old Testament becomes more understandable and relevant showing the role that such places, events, peoples, systems and prophecies had in Jesus' life, and how the Old Testament Sacrificial System is fulfilled in the Life of Christ.
4) Proportional to reading time is an improved handle on vocabulary and history as well as an enhanced sense of wisdom, error, and of right and wrong.
5) Vocabulary and spelling skills naturally increase in proportion to use of the method so that scholastic performance of students is heightened when this ALR Method is added to a student's curriculum.
6) Each session gives clearer views of what pleases and displeases the Creator.
7) The method facilitates integration and relevance of the ARL sections of the Judeo Christian Bible, illuminating the continuity of principles and prophecies of Christianity.

### Conclusions, Ramifications and Scope

This method helps alleviate difficulty of too much time spent on difficult portions of the Bible prior to this method which often led to loss of interest, while the method allows near-simultaneous reading of more engaging sections, such as problem solving in the Wisdom section while seeing Christ's wisdom and justice in one section in every session. This immediately pulls the reader into that magnetic centerpiece of the Bible from the first session.

The ALR Method gives a new grasp of Bible scope and contents by re-defining traditional Old and New Testament divisions into New Sections such as History, Wisdom and Prophecy and the New Testament into Life and Mind of Christ and Church History.

A more clear perspective is gained on what is in such categories, kindling curiosity. Brevity and frequency of reading sessions reaching far into the Bible creates confidence, motivation to read and a lasting sense of satisfaction about the Truth in God's Word.

ARL Method's sectional “structure” makes long sections more tolerable by quickly relating them to more personally relevant sections. Importantly, the timing cycles inherent in the method's sizing of sections result in more reading of more-captivating shorter sections of Jesus' Life, Church formation and End Times, while reminding of God's Old Testament rewards to those who serve and his vengeance on those who do not. The method gives psychological permission to “jump to the end” in every session without guilt for being bored by parts that seem unrelated to modern life. Impatient modern readers are soon and often rewarded-reinforced for brief reading of difficult older parts. The method enables small group and family participation to increase interest and involvement, with group reading optional.

Within only 30 reading sessions, a reader will have read the life of Christ at least once in the first books of the New Testament and read how people sought to be saved. Even if reading stops soon after, those early sessions provide information vital to the Christian faith.

The Loop Reading Method enables would-be readers and converts to take a quick, fresh look at this mostly-misunderstood and admittedly difficult-to-read Book for quicker rewarding views of the Bible to appreciate a Creator who is often misunderstood because of misperceived incongruence of the Old and New Testament Scriptures as to how God acted “in the past” versus when He became man and walked on this earth in the flesh (John 1:1-14).

This unobvious Bible reading method reinforces reading by pairing rewarding easy-to-understand personally relevant portions with difficult historical, cultural and philosophical sections that require slow-growing familiarity. The method helps minimize boredom in difficult Old Testament chapters. Easier sections help define older harder sections, keeping the reader chipping away at all sections together in a new way with sections building on each other for growing familiarity such as to identify locations, tribes, philosophies and governing divisions, such as origins of Scribes, Pharisees and Hebrew traditions, read in small tolerable doses and like “immersion” learning of language (learning by often doing).

The many specifics of the examples above should not be construed as limiting the scope of the embodiments but as merely illustrations of the presently preferred embodiments. Such exemplars do not limit the aspects and concepts of the instant invention because other comparable or usable parameters, ranges, values, shapes and appearances may be substituted.

This description will enable others skilled in the art to best utilize and practice the invention in various embodiments and with various modifications as are suited to a particular use. The scope of the invention is defined by the following claims.

What is claimed is:

1. A System to sectionalize the Christian Bible by topic into three or more (Five or Six in preferred embodiments) Reading Loop Sections to give Bible Readers a quicker overall understanding of the Bible as shown in the preferred Classic Protestant Bible Version:

| SECTION | READING LOOP | | CHAPTER |
|---|---|---|---|
| No. | SECTION | TOPIC | COUNT |
| Section One: | Genesis through Esther | History | (436 Chapters) |
| Section Two: | Job through Song of | Wisdom | (243 Chapters) |
| | Solomon | | |
| Section Three: | Isaiah through Malachi | Prophecy | (250 Chapters) |
| Section Four: | Matthew through John | Life of Christ | (89 Chapters) |
| Section Five: | Acts through Revela- | Church History | (171 Chapters) |
| | tion | | |

This System incorporates a combination of a) a method of reading to encourage and motivate Bible reading and b) a reading control system to present brief selections from each of these broad new topical sections of a Christian Protestant or Catholic Bible to accelerate understanding and reinforce Bible reading habit by a readers' frequent sampling of one chapter (or similar amount) from each such new section in each reading session from a base classic Christian Catholic or Protestant Bible wherein in all embodiments provide:
(A) The Accelerated Reading Loop Method and (B) instructions of such Method stating the rules, procedures, timing, and marking of reading position and direction (sequential flow and looping) to readers of such newly divided Accelerated Reading Loop Bible as follows:
Readers shall read . . .
i) in reading sessions as frequent as possible as suited to readers, alone or in a group,
ii) one chapter-selection per section from each of all (five or six) sections of the Bible in sequence front to back such chapters together in each reading session,
iii) reading sequentially by chapter each chapter in sequence in each subsequent reading session, such position retained by a bookmark for each section,
iv) maintaining a bookmark position indicator to be placed at end of each chapter read (completed) in each session.(which marks next chapter in section)
v) each Reading Loop Section to be repeated in a “loop” on completion of each section while maintaining the reading point position in other sections, whereby said combination and method will accelerate readers' familiarity with major parts of the Bible to give rapid exposure to one or more captivating section while minimizing time on difficult parts, encouraging the reader to “jump ahead” without guilt, motivating impatient readers needing frequent reinforcement and change, focusing most effort on reading, not discussion, meeting modern time constraints, brief attention spans or preference for independence.

2. The Bible Reading Loop System of claim 1 that provides a new reading method and structure in said Bibles by superimposing said new broad topical Sections (divisions) by topical categories related to subject matter content of each section, superimposed over classic divisions (book-chapter-verse, Old and New Testaments of Classic Bible Versions) and adds an additional Reading Loop Section entitled Apocrypha for the Catholic Bible embodiment.

3. The Bible Reading Loop System of claim 1 for the classic Bible book embodiment that provides a means of identifying the new topical sections by visual indicators of such sections such as dividers, thumb index, section title pages and/or other visual differences like colors.

4. The Bible Reading Loop System of claim 1 in a copyrighted computer embodiment shows the new topical sections as multiple colors on a computer monitor screen to distinguish such new Sections and allows the reader to read the Bible using the Accelerated Reading Loop “ARL” System of Broad Topical Sections in Sessions containing (in the preferred embodiment) all 5 sections and track such reading progress.

5. A Combination of (1) A Multiple Colored Book Edge For Easy Identification of Bible Sections Combined with (2) A Matching Set of Colored Book Markers for Bookmarking each Colored Reading Loop Section
Wherein:
a) book edge coloring is achieved by Four Color Process to color outside perimeter edges of every page 44 (FIG. 4B) of each section so color bleed is seen on the entire book edge (top 32, fore 36 and bottom 34 edges).
b) identifying multiple colored sections are on a Bible's entire book edge 40 (FIGS. 3 and 4B)
c) matching bookmark ribbons or other bookmark 50 FIG. 3A provide the means to mark and track reading location within each distinctly-colored topical section, such sub-system of colored book edge section identifiers combined with matching bookmarks is unique and unobvious.
d) The “color bleed” method to color a book edge is an unobvious technique that differs from a solid gilded book edge process (G. M. Cross U.S. Pat. No. 3,200,029) and provides a multiple striped book edge 40 (FIG. 4B) not used before for the purpose of identifying new topical sections of the Bible, which provides an initial grasp of the Bible's overall structure not apparent or understood by many before because of long standing traditional Bible divisions.

6. The Book Edge Coloring with Matching Bookmarks of claim 5 wherein any Bible can be transformed into an Accelerated Reading Loop Bible by using the kit embodiment described in FIG. 5 that provides colored markers 54 and a bookmark clip 52 with multiple ribbons 50 or bookmarks corresponding in number and color to the number of Sections to be colored. Said Bookmark within each ARL Bible Transformation kit attaches to the target Bible to be sectionalized and transformed to an “ARL” to keep track of multiple section reading positions.

7. A method of fast, brief and broad parallel sampling reading of the Bible from new superimposed broad topical sections, sequentially in frequent sessions to encourage frequent Bible reading of diverse Bible portions comprising the steps of :
selecting and superimposing topical sections by content type upon the classical Bible divisions;
selecting such topical sections so that more interesting new parts of the Bible are smaller than sections superimposed on older content of the Bible;
selecting such new divisions-sections to fall in size between the largest classical divisions and the next lower divisions (between Testaments and books in Bibles);
providing Notice and Instructions to be followed that outline the method;
imposing method rules of brief reading sessions in which a subsequent small part or chapter, from each of three or more said new sections of the Bible, is each read in each session
wherein readers shall read . . .
i) in reading sessions as frequent as possible, alone or in a group,
ii) one chapter (or pre-set selection) per section from each of all sections of the Bible in sequence front to back such one selection per section read together in each reading session,
iii) advancing reading sequentially by chapter each chapter (or selection) in sequence in each subsequent reading session, such position retained by a bookmark for each section,
iv) maintaining a bookmark position indicator to be placed between the last chapter-selection read (completed) and that next-to-be-read in next session.
v) each Section to be repeated in a “loop” on completion of each section, regardless of the reading point position in other sections.
imposing rules of a flow of reading by instructions to: in first session to read beginning at the first chapter of each section, continuing where left off in each ARL “reading loop” section as book marked for each section in each session, read in sequence from section one to last section within each session, to read one chapter or pre-set brief selection in each section per session by beginning reading in the first section at the point book-marked where left off in the prior session, and likewise reading from each bookmark in each section in classical Bible chapter-verse order in subsequent sessions;
imposing a rule that when reading of a section is done, reading shall “loop” and restart at the beginning of that section, hence called a “reading loop”;
positioning and applying such new sections upon a Christian Bible by topical categories related to content type of each section superimposed over classic divisions (book-chapter-verse, Old-New Testament and Deuterocanonical books) of Bibles;
identifying such superimposed new sections by visual indicators of such sections upon pages or computerized display to show and distinguish such new topical sections, providing multiple reading position pointer bookmarks equal in number to number of sections for reader to keep track of reading position within each Section,
whereby said method will accelerate readers' familiarity with major broad parts of the Bible to give rapid exposure to one or more captivating sections while minimizing time on difficult parts, encouraging the reader to “jump ahead” without guilt, motivating impatient readers, focusing most effort on reading, meeting modern time constraints, brief attention spans or preference for independence.

8. The Bible Reading Method of claim 7 wherein a preferred embodiment of the classic Protestant (or Catholic) Bible Book is divided into the following five (or six) topical sections and chapter count:

| SECTION | READING LOOP | | CHAPTER |
|---|---|---|---|
| No. | SECTION | TOPIC | COUNT |
| Section One: | Genesis through Esther | History | (436 Chapters) |
| Section Two: | Job through Song of | Wisdom | (243 Chapters) |
| | Solomon | | |
| Section Three: | Isaiah through Malachi | Prophecy | (250 Chapters) |
| (Section Six): | Esdras-II Maccabees | Apocrypha | (168 Chapters) |
| Section Four: | Matthew through John | Life of Christ | (89 Chapters) |
| Section Five: | Acts through Revela- | Church History | (171 Chapters) |
| | tion | | |

9. The Bible Reading Method of claim 7 wherein any Bible can be transformed into An ARL Reading Method Bible by a kit containing colored markers and a set of matching colored bookmarks to divide a plain Protestant (or Catholic) Bible into the preferred embodiment with five (or six) topical sections and chapter count as follows:

| SECTION | READING LOOP | | CHAPTER |
|---|---|---|---|
| No. | SECTION | TOPIC | COUNT |
| Section One: | Genesis through Esther | History | (436 Chapters) |
| Section Two: | Job through Song of | Wisdom | (243 Chapters) |
| | Solomon | | |
| Section Three: | Isaiah through Malachi | Prophecy | (250 Chapters) |
| (Section Six): | Esdras-II Maccabees | Apocrypha | (168 Chapters) |
| Section Four: | Matthew through John | Life of Christ | (89 Chapters) |
| Section Five: | Acts through Revela- | Church History | (171 Chapters) |
| | tion | | |

10. The ARL Bible Reading Method of claim 7 in a preferred embodiment with five topical sections and chapter count as follows:

| SECTION | READING LOOP | | CHAPTER |
|---|---|---|---|
| No. | SECTION | TOPIC | COUNT |
| Section One: | Genesis through Esther | History | (436 Chapters) |
| Section Two: | Job through Song of | Wisdom | (243 Chapters) |
| | Solomon | | |
| Section Three: | Isaiah through Malachi | Prophecy | (250 Chapters) |
| Section Four: | Matthew through John | Life of Christ | (89 Chapters) |
| Section Five: | Acts through Revela- | Church History | (171 Chapters) |
| | tion | | |

employed with on line web access software program enabled by Javascript aka Copyright No. 1-45824848, Titled: “Advanced Reading Loop” filed on Aug. 4, 2010 (with (to date) no public access given) that with functionality described in FIG. 6 and displayed like FIGS. 8 and 8A which provides approximately 22,394,758,500 possible ARL Reading Loop session combinations, making a full printed version with every possible ARL Session combination impractical.

11. The Bible Reading Method of claim 7 in a preferred embodiment with five topical sections and chapter count where Advanced Audio-Video application for simultaneous viewing and listening capability 110, 111 as in U.S. Pat. Applic. Publ No. US 2008/0005656 A1, Pang, Pang, Pang & Mullins [0109] can be used in the preferred embodiment to learn the teachings and lessons of the Bible or simply learn to read and pronounce words of any language the ARL Bible might be translated into.

12. The Bible Reading Method of claim 7 in a preferred embodiment with five topical sections made to be transmitted electronically and:
(a) enabled by Javascript or any preferred computer or web language
(b) downloaded onto a mobile device as an application.
(c) this downloadable “app” could be considered an offline “web browser application”.
(d) take other forms as technology advances
(e) performs most of the basic functions as the computer embodiment in FIGS. 6-8A

13. The Bible Reading Method of claim 7 in a preferred embodiment with five topical sections where the ARL Reading Loop Method can take form as a windows application that:
(a) functions as a web browser
(b) displays html pages and allows navigation of the pages
(c) keeps track of the bookmarks (via cookies or some other mechanism.)
(d) use Javascript or any other preferred language to enable functionality
(e) performs most basic functions as the computer embodiment in FIGS. 6-10

14. The Bible Reading Method of claim 7 in a preferred embodiment with five topical sections where the preferred ARL Reading Loop Bible embodiment can be downloaded onto an electronic reader (like Kindle) this embodiment would:
(a) divide the Bible Text into three or more topical sections (five in a preferred embodiment)
(b) keep track of reading progress with book marks
(c) contain rules and instructions for using the “ARL Bible” reading method
(a) give electronic book the basic features of the computer embodiment in FIGS. 6, 8 and 8A.
(b) use Javascript or any other preferred language to enable functionality

15. The ARL Bible Reading Method of claim 7 superimposed over any Classic Catholic or Protestant Bible version in any Language translation wherein possible embodiments include but are not limited to (a) Traditional Book Form, (b) Electronic Book Form, (c) Conversion of a Bible using an ARL Kit, (d) On line Access through Computer Hardware, (e) a Compact Disc for audio or reading Bible text on computer, (f) Digital Video Disc, (g) Web Application or other “DROID” type Applications for Downloading on Mobile Devices, (h) Advanced Audio-Video application for simultaneous viewing and listening capability as in U.S. Pat. Applic. Publ No. US 2008/0005656 A1, Pang, Pang, Pang & Mullins [0109] (i) or any other means of providing the ARL Bible Reading Method as described herein.
